(19) United States
(12) Patent Application Publication
(10) Pub. No.: US 2017/0344406 A1
(43) Pub. Date: Nov. 30, 2017

(54) DATA PROCESSING APPARATUS, DATA PROCESSING METHOD, AND NON-TRANSITORY COMPUTER READABLE MEDIUM

(71) Applicant: KABUSHIKI KAISHA TOSHIBA, Tokyo (JP)

(72) Inventors: Takahiro YAMAURA, Kawasaki (JP); Takeshi ISHIHARA, Yokohama (JP)

(73) Assignee: KABUSHIKI KAISHA TOSHIBA, Tokyo (JP)

(21) Appl. No.: 15/444,730

(22) Filed: Feb. 28, 2017

(30) Foreign Application Priority Data
May 31, 2016 (JP) 2016-108714

(51) Int. Cl. G06F 9/54; G06F 9/30; G06F 9/455; H04L 29/06

(52) U.S. Cl. CPC G06F 9/545; H04L 69/16; G06F 9/30; G06F 9/45545

(57) ABSTRACT

A data processing apparatus according to the embodiment of the present invention includes a storing device configured to store a file, and an OS configured to operate in the kernel space. The OS includes a file access manager, a presence determiner, and a writer. The file access manager detects a file access to a file in the storing device by an application operating in the user space. The presence determiner determines whether the file pertaining to the file access detected by the file access manager is stored in the storing device. When the presence determiner determines that the file pertaining to the file access is not stored in the storing device, the writer writes the file pertaining to the file access detected by the file access manager into the storing device.

### CROSS-REFERENCE TO RELATED APPLICATION(S)

This application is based upon and claims the benefit of priority from Japanese Patent Application No. 2016-108714, filed May 31, 2016; the entire contents of which are incorporated herein by reference.

### FIELD

Embodiments described herein relate generally to a data processing apparatus, a data processing method and a non-transitory computer readable medium.

### BACKGROUND

In a data processing apparatus mounted with an Operating System (OS), an application and the like to be executed by a user is executed in a user space while the OS and the like that operate hardware are executed in a kernel space. Consequently, programs executed in the user space cannot directly access the hardware.

Operation of a file and the like stored in a storage requires a process (system call) of calling a function of the OS which is executed in the kernel space. Even if a storage or the like that can be shared by a plurality of applications are provided, there is a problem in that a load or delay due to a system call occurs.

### BRIEF DESCRIPTION OF THE DRAWINGS

FIG. 1 is a block diagram illustrating an example of a schematic configuration of a data processing apparatus according to a first embodiment;

FIG. 2 is a block diagram illustrating an example of a hardware configuration according to the first embodiment;

FIG. 3 is a diagram illustrating a configuration of a file system of the data processing apparatus according to the first embodiment;

FIGS. 4A, 4B and 4C are diagrams illustrating examples of access right information according to the first embodiment;

FIG. 5 is a diagram illustrating an example of a flowchart of a schematic process of the data processing apparatus according to the first embodiment;

FIG. 6 is a diagram illustrating an example of a flowchart of a reading process of the data processing apparatus according to the first embodiment;

FIG. 7 is a diagram illustrating an example of a flowchart of a writing process of the data processing apparatus according to the first embodiment;

FIG. 8 is a block diagram illustrating an example of a schematic configuration of a data processing apparatus according to a second embodiment;

FIG. 9 is a diagram illustrating an example of instruction information;

FIG. 10 is a diagram illustrating an example of a flowchart of a reading process of the data processing apparatus according to the second embodiment;

FIG. 11 is a block diagram illustrating an example of a schematic configuration of a data processing apparatus according to a third embodiment;

FIG. 12 is a block diagram illustrating an example of a hardware configuration according to the third embodiment;

FIG. 13 is a diagram illustrating an example of a flowchart of a reading process of the data processing apparatus according to the third embodiment;

FIGS. 14A, 14B and 14C are diagrams illustrating examples of virtualization techniques;

FIG. 15 is a block diagram illustrating an example of a schematic configuration of a data processing apparatus according to a fourth embodiment;

FIG. 16 is a diagram illustrating an example of access right information according to the fourth embodiment;

FIG. 17 is a diagram illustrating an example of instruction information according to the fourth embodiment; and

FIG. 18 is a diagram illustrating an example of a flowchart of the data processing apparatus according to the fourth embodiment.

### DETAILED DESCRIPTION

An embodiment of the present invention reduces the number of processes between a user space and a kernel space, thereby reducing the load on or delay of processing.

A data processing apparatus according to the embodiment of the present invention includes a storing device configured to store a file, and an OS configured to operate in the kernel space. The OS includes a file access manager, a presence determiner, and a writer.

The file access manager detects a file access to a file in the storing device by an application operating in the user space.

The presence determiner determines whether the file pertaining to the file access detected by the file access manager is stored in the storing device.

When the presence determiner determines that the file pertaining to the file access is not stored in the storing device, the writer writes the file pertaining to the file access detected by the file access manager into the storing device.

Below, a description is given of embodiments of the present invention with reference to the drawings. The present invention is not limited to the embodiments.

### First Embodiment

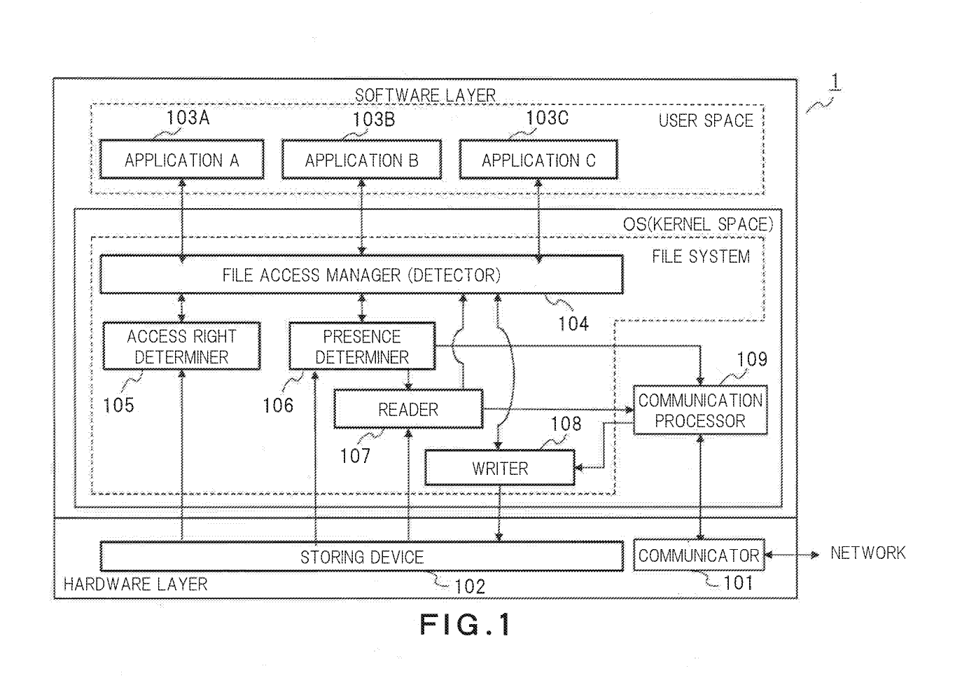

FIG. 1 is a block diagram illustrating an example of a schematic configuration of a data processing apparatus 1 according to a first embodiment. The data processing apparatus 1 according to the first embodiment includes a communicator 101, a storing device 102, at least one application 103, a file access manager (detector) 104, an access right determiner 105, a presence determiner 106, a reader 107, a writer 108, and a communication processor 109. When a plurality of applications 103 are to be discriminated from each other in the description, the discrimination is made based on alphabetical subscripts as indicated in FIG. 1 such as applications 103A to 103C.

The data processing apparatus 1 of this embodiment is mounted with any OS and is implemented as a general computer apparatus that causes software (programs) to operate. Among configuration elements of the data processing apparatus 1, elements implemented by software processing are represented in a software layer, while elements implemented by hardware processing are represented in a hardware layer. The type of the data processing apparatus 1 is not specifically limited. This apparatus may be, for example, a PC (Personal Computer), a server, a tablet or the like.

In an address space where software operates, a space (kernel space) in which the OS operates and a space (user space) in which programs used by a user operate are separated from each other. Here, the programs that operate in the user space are called “applications”.

As illustrated in FIG. 1, the applications 103 operate in the user space. The file access manager 104, the access right determiner 105, the presence determiner 106, the reader 107, the writer 108, and the communication processor 109 operate as a part of the OS in the kernel space. The storing device 102 and the communicator 101 operate in the hardware layer. The file access manager 104, the access right determiner 105, the presence determiner 106, the reader 107, and the writer 108 may be implemented as a single file system in the OS of the data processing apparatus 1.

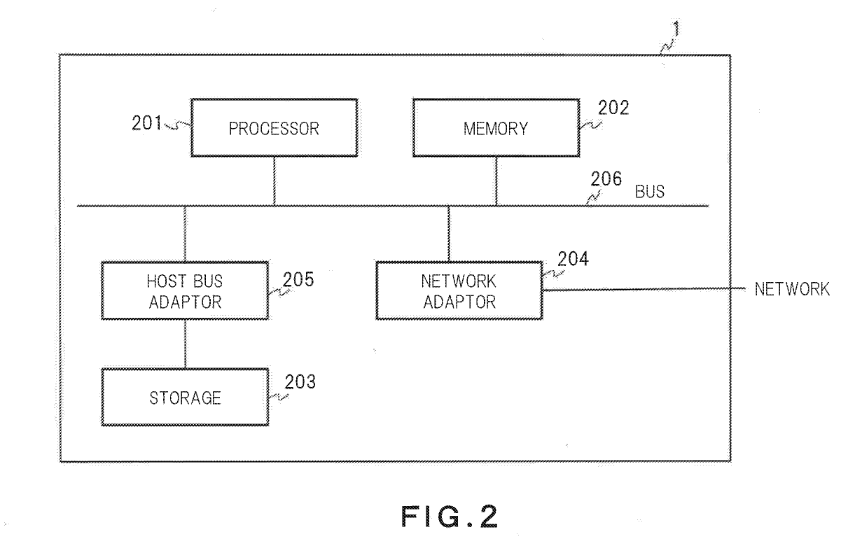

FIG. 2 is a block diagram illustrating an example of a hardware configuration of the data processing apparatus 1 according to the first embodiment. In the example of FIG. 2, the data processing apparatus 1 is represented as a computer apparatus 2 that includes a processor 201, a memory 202, a storage 203, a network adaptor 204, and a host bus adaptor 205. The processor 201, the memory 202, the network adaptor 204, and the host bus adaptor 205 are connected via a bus to each other. The host bus adaptor 205 is connected to the storage 203. The network adaptor 204 is connected to an external network. Besides these elements, an input device and an output device may further be provided. Each configuration element of the hardware may be a single element as in FIG. 2, or a plurality of elements.

The processor 201 is an electric circuit that includes a control device and an operation device of the computer. The term “processor” should be widely construed, and encompasses a Central Processing Unit (CPU), a microprocessor and the like. The term may further encompass processors for assisting the processor. The processors may be a digital signal processor, a graphic processor, a processor for peripheral devices.

The memory 202 is a memory device that temporarily stores instructions to be executed by the processor 201, various types of data and the like. This memory may be a volatile memory, such as DRAM, or a nonvolatile memory, such as MRAM.

The storage 203 is a storage device that permanently stores programs, data and the like. The storage may be, for example, a hard disk, an SAN (Storage Area Network), an optical disk, a flash memory, magnetic tape or the like.

The network adaptor 204 is an interface for wireless or wired connection to a communication network. The network adaptor 204 may be an adopter that conforms to an existing communication standard.

The host bus adaptor 205 is an interface for connection to the storage. The connection standard is not specifically limited.

The processor 201 executes programs stored in the memory 202 or the storage 203, thereby implementing the application 103, the file access manager 104, the access right determiner 105, the presence determiner 106, the reader 107, the writer 108, and the communication processor 109.

The storing device 102 is implemented any or both of the memory 202 and the storage 203. The communicator 101 is implemented by a network adaptor.

The data processing apparatus 1 according to this embodiment may be implemented by preinstalling programs to be executed. Alternatively, this apparatus may be implemented by storing the programs in a storing medium, such as CD-ROM, or distribution via a network and by appropriately installing the programs.

The details of each of the elements that constitute the data processing apparatus 1 are described.

The communicator 101 is a network interface for communication with an external apparatus via a communication network according to a communication scheme defined by IEEE 802.3 standard or the like. In this embodiment, for example, communication is performed in a case where the data processing apparatus 1 receives a file or the like that this apparatus does not hold from an external apparatus (origin server) and a case where the data processing apparatus 1 transmits a file that this apparatus holds to an external apparatus (client). The communicator 101 may be a virtual interface created by a VLAN (Virtual Local Area Network), VXLAN (Virtual eXtensible Local Area Network), or VPN (Virtual Private Network).

The storing device 102 stores data, such as files. For example, the stored data may be a cache (temporarily used data), such as of files downloaded by the communicator 101. The storing device 102 may store access right information to be used by the access right determiner 105. A storing device 102 that stores files and a storing device 102 that stores access right information may be achieved by different memories or storages. The details of the access right information are described later.

The application 103 performs a file access to the file in the storing device 102. The file access means instructions pertaining to the file, such as creating, reading, writing, deleting, and transmitting. More specifically, the file access means a system call to the OS of the data processing apparatus 1.

When a program operating in the user space uses a function of the OS operating in the kernel space or a resource in the hardware, a system call is used. The system call calls the function of the OS operating in the kernel space, such as a file system, and allows the file and the like stored in the hardware to be used. Depending on the type of OS, instead of the name of system call, which is sometimes referred to as another name, such as a service call, supervisor call, or API (Application Programming Interface). Here, a process of the application for calling a program operating in the kernel space is uniformly referred to as a system call.

The application 103 calls an “open” system call with designation of the path of a file, thereby obtaining a file descriptor corresponding to the desired file. The application 103 can perform various processes using the file descriptor.

For example, calling a “read” system call with designation of a memory from which reading is to be made and the length of reading allows the data on a file in the storing device 102 to be read. Calling a “sendfile” system call with designation of the file descriptor, the offset of data in the file, the length of data, and the socket for communication allows the data of the file in the storing device 102 to be transmitted to the communication processor 109 via the socket. Calling a “write” system call with designation of the address of memory where the data on the file to be written is stored and the length of the data allows the designated file to be written in the storing device 102. Even in a case of the same process, different system calls may be used according to the situations. For example, to read the data on the file, the “read” system call may be used in some cases and the “mmap” system call may be used in other cases.

The file access manager (detector) 104 is an interface of the file system. When the application 103 calls a system call pertaining to a file in the storing device 102, the file access manager 104 detects this system call.

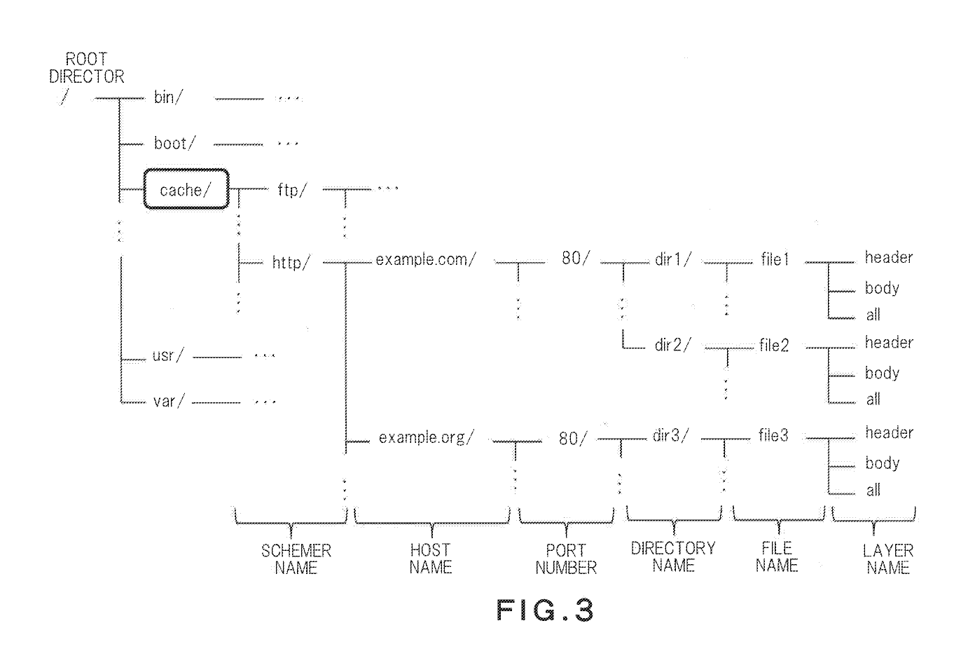

FIG. 3 is a diagram illustrating a configuration of a file system of the data processing apparatus 1 according to the first embodiment. “/” at the upper left of FIG. 3 indicates a root directory. Directory trees, such as “/bin”, “/boot”, “/cache”, “/usr” and “/var”, immediately below the root directory are implemented by each file system provided by the OS.

For example, the application 103 is a web server that provides web services, and transmits files, such as web pages, cached in the storing device 102. It is assumed that a file to be transmitted resides under the “/cache” directory directly below the root directory. In such an example, the file access manager 104 in the file system mounted on the “/cache” directory receives a system call from the application 103.

In the above example, it is assumed that the application 103 tries file access through an “open” system call with designation of a path, such as “/cache/schema name/host name/port number/directory name/file name/area name”, as illustrated in FIG. 3. For example, when the body part of URI (Uniform Resource Identifier), “http://example.com/dir1/file1”, is required, the application 103 converts the URI into a path, “/cache/http/example.com/80/dir1/file1/body” and performs a file access. When the header part is required, conversion is performed into “/cache/http/example.com/80/dir1/file1/header”. When all the parts are required, conversion is performed into “/cache/http/example.com/80/dir1/file1/all”. The area names are different according to the schemers.

The file access manager 104 obtains path information, access type information, and application execution information, from the “open” system call. These pieces of information are transmitted to the access right determiner 105, the presence determiner 106 and the like. The path information is information related to the path of the file pertaining to the file access. The access type information is information related to the file access type, such as reading, writing, and executing. The application execution information is information related to the application 103 that performs the file access. For example, the application execution information contains an application identifier for identifying the application 103, a user identifier for identifying a user who are executing the application 103, and a group identifier for identifying a group to which the user belongs. The application identifier may be a process ID assigned by the OS, for example.

The file access manager 104 returns a process result by the system call to the application 103 having called the system call. The process result by the system call may be a required file descriptor, the number of processed bytes, an error in a case of failure in the request or the like.

When the process is completed, the application 103 calls a “close” system call and closes the file descriptor. At this time, the file access manager 104 may detect the “close” system call in the writing process, and notify the completion of the process to the reader 107, writer 108 and the other applications 103 and the like, which are waiting for the completion of writing. The notification may be issued to all the elements that are waiting for the completion of writing. Alternatively, the notification may be issued to some elements with a priority. Instead of the file access manager 104, the application 103 may issue the notification. The file access manager 104 may receive a report of the completion of the process from the access right determiner 105, the presence determiner 106, the reader 107, the writer 108 or the like and then notify start of the next process to the corresponding elements.

The access right determiner 105 determines file access permission or prohibition detected by the file access manager, on the basis of the access right information. The access right information indicates the access right where file access permission or prohibition is set on a file-by-file basis or a directory-by-directory basis.

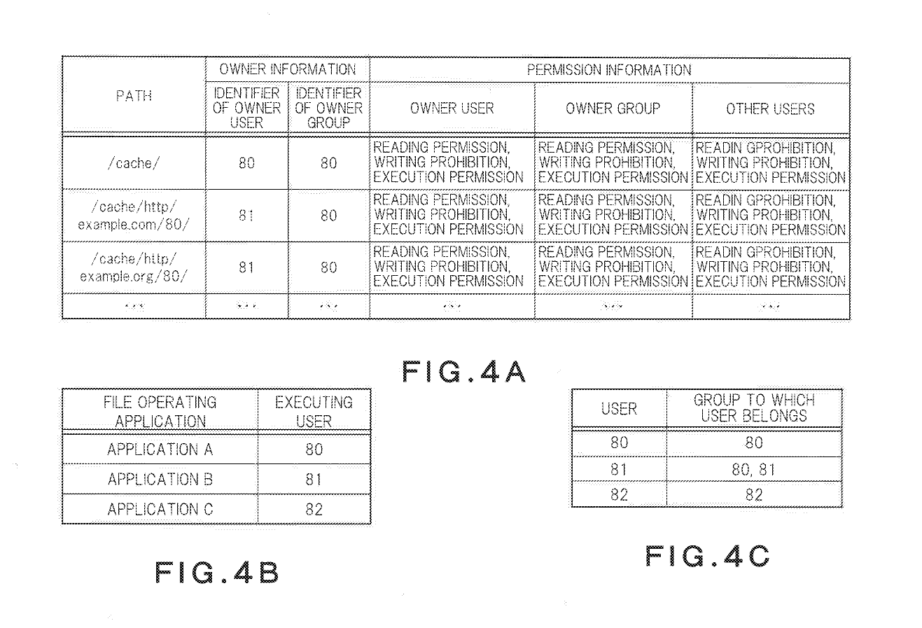

FIGS. 4A, 4B and 4C are diagrams illustrating examples of access right information according to the first embodiment. FIG. 4A illustrates an example of access right information on each path. FIG. 4B illustrates the relationship between the applications 103 and users executing the respective applications 103. FIG. 4C illustrates the relationship between the users and groups to which the users belong. The identifiers of the users and the groups are uniquely assigned by the OS.

FIG. 4A illustrates the path of the file, and owner information and permission information on the file. The owner information includes the identifier of an owner user and the identifier of an owner group. In the example of this diagram, the pieces of permission information are classified into those for the owner users, owner groups, and other users. The access rights of execution, reading and writing in each classification are illustrated (permission or prohibition in FIG. 4A). There may be another classification which is not illustrated.

The access right determiner 105 refers to the access right information as in FIGS. 4A, 4B and 4C, and determines the file access permission or prohibition using the path information, access type information and application execution information obtained from the file access manager 104. For example, provided that each application 103 is executed by the user illustrated in FIG. 4B, a file access to the file under “/cache” directory by the application 103C is determined not to permitted (prohibited). A user who has a user ID of “82” and executes the application 103C is not the owner user and does not belong to the owner group. Consequently, the user is classified into one of the other users. The other users are prohibited from reading, writing and executing the file. Thus, such determination is made. On the other hand, the users executing the applications 103A and 103B are the owner user or belong to the owner group. Consequently, in cases of reading and execution, file accesses to “/cache” by the applications 103A and 103B are determined to be permitted. In a case of writing, the file accesses are determined not to be permitted (prohibited).

File access permission or prohibition of a file having not been created may be determined such that the access right information on the directory higher on the path is inherited.

The access right determiner 105 notifies the determination result to the file access manager 104. When the determination result is “prohibited”, that is, when file access cannot be performed, the file access manager 104 sets the return value of the system call to an error and issues notification to the application 103. For example, when the applications 103A and 103B try to perform writing to the file in the “/cache” directory, an error is notified to the corresponding applications 103 because writing is prohibited.

The access right determiner 105 thus determines the file access permission or prohibition from the application 103. Consequently, a file access from the application 103 having a high security risk can be prevented. On the other hand, the application 103 that is permitted to perform reading can use the file in the storing device. Consequently, unnecessary communication can be avoided.

The presence determiner 106 determines whether the file pertaining to the file access detected by the file access manager 104 is stored in the storing device 102 on the basis of the path information. In a case where the file is stored in the file storing device 102, it may further be determined whether the file is valid. For example, when a predetermined expiration time after the file being cached has been reached, the determination result may be set to “prohibited” because no valid file resides.

The method of determining whether the file is valid or invalid is different according to each schemer. For example, in a case of HTTP, determination may be performed using “Expires”, “max-age”, “Last-Modified”, “Date” fields and the like, which are contained in a header. Through “Expires”, “max-age” or the like, it can be determined whether the expiration time has not currently been reached yet. Alternatively, the validity of the file may be estimated using “Date” and “Last-Modified”, and determination may then be made. The presence determiner 106 may obtain these fields from the HTTP header stored in the storing device 102.

Thus the validity of the file can be secured.

The communication processor 109 is actually implemented using, for example, a TCP/IP protocol stack, a network device driver or the like, and controls the communicator 101 to communicate.

The communication processor 109 controls the communicator 101 to thereby receive the file and the like pertaining to the file access detected by the file access manager 104, from an external apparatus, e.g., a server on a network or the like. For example, when the application 103 performs a file access to “/cache/http/example.com/80/dir1/file1/body”, the communication processor 109 receives the file using a character string after “/cache/”, i.e., “http://example.com/80/dir1/file1”. The method of receiving the file is different according to each scheme. For example, in a case of HTTP, connection is established to the port “80” of example.com in TCP (Transmission Control Protocol), and subsequently, the file is received using a “HEAD” method, a “GET” method and the like of HTTP. For example, first, information on the header may be received using the “HEAD” method, it may be determined whether the file stored in the storing device 102 is updated, and information on the body may be received through the “GET” method as required.

The reader 107 reads the file from the storing device 102 according to the type of the system call, and provides the read file to each element that requires the file.

For example, when the file access manager 104 detects reading of the file through the system call, such as “read”, the reader 107 reads the file from the storing device 102, and transmits the file through the file access manager 104 to the application 103 having called the system call. More specifically, the reader 107 writes the data read from the storing device 102 in a memory area set by the application 103 at the time of system call, and notifies the number of bytes written as a processing result to the application 103. When the file access manager 104 detects file transmission by the system call, such as “sendfile”, the reader 107 reads the file from the storing device 102 and then transmits the file to the communication processor 109.

The writer 108 writes the received file in the storing device 102. The writer 108 may obtain the data on the file from the application 103 through the file access manager 104. For example, when the file access manager 104 detects file writing by the system call, such as “write”, the data is read from the memory area set by the application 103 at the time of system call, and the writer 108 writes the data as a file in the storing device 102. The number of written bytes is notified to the application 103 via the file access manager 104. The data on the file may be obtained from the communication processor 109 without intervention of the application 103. In this embodiment, when the file called by the application 103 is absent in the storing device 102, the writer 108 obtains the file from the communication processor 109 and writes the file in the storing device 102 even without a writing instruction from the application 103 having performed the file access. That is, when the file called by the application 103 is absent in the storing device 102, file access pertaining to writing by the application 103 is not performed.

A typical web server and the like obtain, from an external apparatus or the like, the file requested by the web server, when the file is absent. Consequently, exchange of data between the user space and the kernel space occurs many times. However, as with this embodiment, execution of the writing process in the OS even without any writing instruction by the application 103 can reduce exchange of data between the user space and the kernel space to reduce the delay of and load on the process.

The destination of writing is determined on the basis of the path information. The path information may be obtained from the file access manager 104, reader 107 or the like. Alternatively, a configuration may be adopted where the necessity of writing is determined on the basis of the update time of each file obtained, and the file determined to be without necessity of writing is not written.

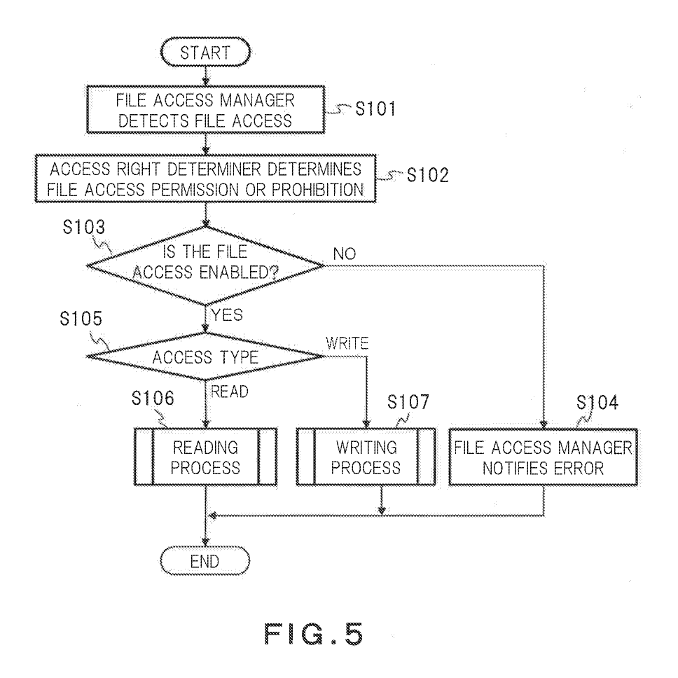

Next, the flow of process of this embodiment is described. FIG. 5 is a diagram illustrating an example of a flowchart of the data processing apparatus 1 according to the first embodiment. The description is made assuming that the application 103 of this embodiment is a web server that transmits a file requested by an external apparatus, not illustrated, on a network. This flow is started when the application 103 calls the system call.

The application 103 calls a system call, which allows the file access manager 104 to detect the file access (S101). The file access manager 104 transmits the path information, access type information and application execution information included in the system call to the access right determiner 105, and the access right determiner 105 determines file access permission or prohibition on the basis of these pieces of information and the access right information (S102).

When the determination result by the access right determiner 105 is “prohibited”, that is, when the file access is disabled (NO in S103), the reading process, writing process or the like is not performed, the determination result is returned to the file access manager 104, and the file access manager 104 notifies an error to the application 103 having called the system call (S104), and this process is finished. When the determination result by the access right determiner 105 is “permitted”, that is, when the file access is enabled (YES in S103), corresponding measures are different according to the access types.

When the system call is “read”, “sendfile” or the like, that is, when the system call is of an access type that requires file reading (“READ” in S105), the reading process is performed (S106). When the system call is “write” or the like, that is, when the system call is of an access type that requires file writing (“WRITE” in S105), the writing process is performed (S107).

After the reading process or the writing process is completed, this flow is finished. The flows of the reading process and the writing process are described later.

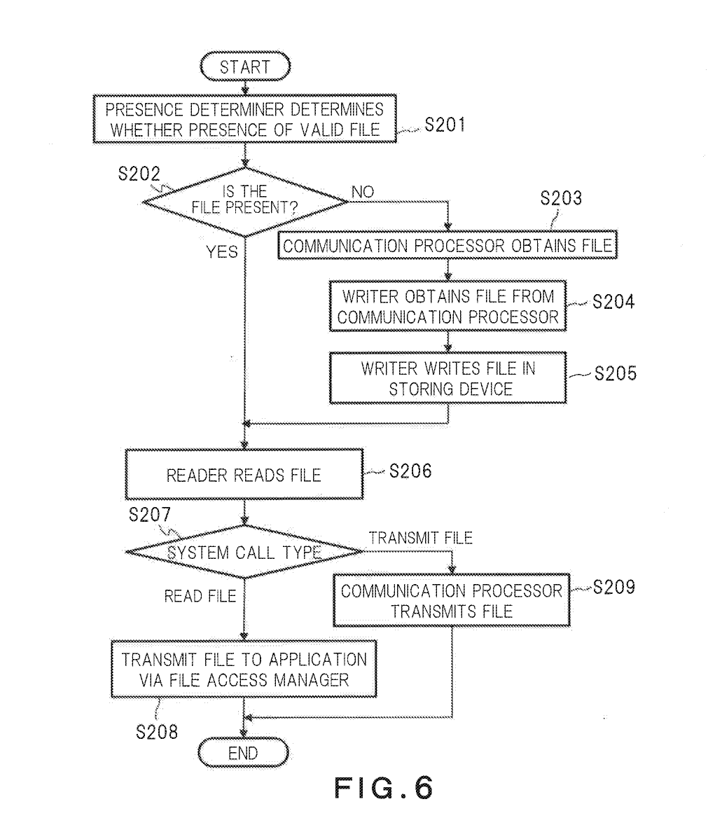

FIG. 6 is a diagram illustrating an example of a flowchart of a reading process of the data processing apparatus 1 according to the first embodiment. The presence determiner 106 determines whether a valid file pertaining to the file access is present in the storing device 102 (S201). The presence determiner 106 may obtain the path information, the access type information and the application execution information from the access right determiner 105 or from the file access manager 104.

When it is determined that the determination result is false, that is, determined that the file pertaining to the file access is absent in the storing device 102 (NO in S202), the communication processor 109 obtains the file on the basis of the path information (S203). The writer 108 then obtains the file from the communication processor 109 (S204), and writes the file in the storing device 102 (S205).

When the determination result is true, that is, when the file pertaining to the file access is present in the storing device 102 (YES in S202), or after the writer 108 writes the file in the storing device 102 (after the process of S205), the reader 107 reads the file pertaining to the file access (S206). After the reader 107 reads the file (after the process of S206), corresponding measures are different according to the system call types.

When the access type is the file reading process, such as “read” (“READ FILE” in S207), the reader 107 passes the read file through the file access manager 104 to the application 103 having called the system call (S208) and this process is finished. When the access type is the file transmission process, such as “sendfile” (file transmission in S206), the read file is transmitted to the communication processor 109, and the communication processor 109 transmits the file (S209) and this flow is finished. The file access manager 104 may read the transmission destination of the file from the system call, and transmit the destination to the communication processor 109.

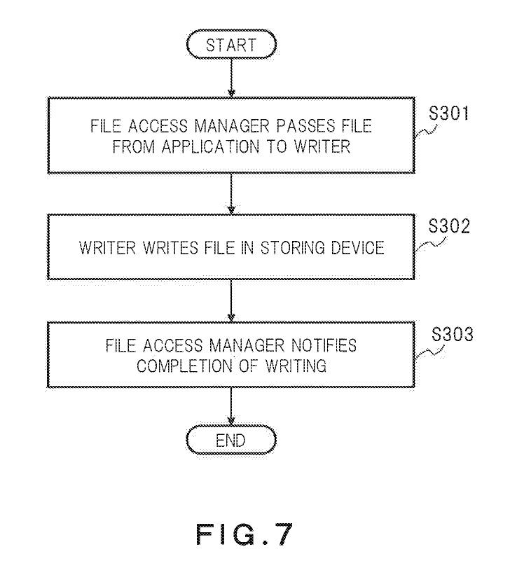

FIG. 7 is a diagram illustrating an example of a flowchart of a writing process of the data processing apparatus 1 according to the first embodiment. The writer 108 writes the data on the file transmitted from the application 103 via the file access manager 104, in an area of the storing device 102 corresponding to the designated path (S302). The file access manager 104 notifies completion of writing to the application 103 (S303), and this flow is finished.

In some cases, not all the files can be written at one time. In such cases, the application 103 may repeatedly call the “write” system call.

As described above, this embodiment can reduce exchange of data between the user space and the kernel space to reduce the delay of and load on the process. The plurality of applications 103 are allowed to share the file, and can reduce the number of times of obtaining files through the communicator 101. Furthermore, the expiration time of the file can be determined, and the validity of the file can be secured. Moreover, file writing by the application 103 that is not allowed to access the file can be limited, which can improve the reliability of the file.

### Second Embodiment

In the first embodiment, when the file pertaining to the file access is absent, the file is written in the storing device 102 without intervention of the application 103 having performed the file access. However, in some cases, the application 103 to be allowed to perform writing is desired to be designated. A second embodiment assumes that a desired application 103 is caused to execute a process, such as obtaining of a file.

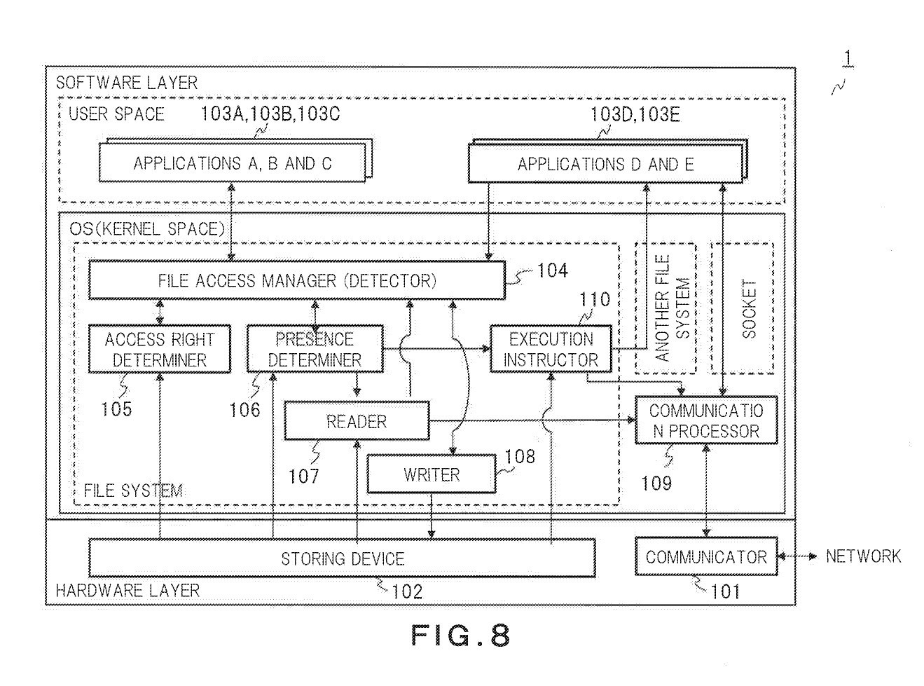

FIG. 8 is a block diagram illustrating an example of a schematic configuration of a data processing apparatus 1 according to a second embodiment. This embodiment further includes an execution instructor 110, and applications 103 that are instructed to execute a process. In FIG. 8, applications 103D and 103E are illustrated as candidates of the applications 103 that are instructed to execute the process. Description on points analogous to those of the first embodiment is omitted. The hardware configuration of the data processing apparatus 1 according to the second embodiment is analogous to that of the first embodiment.

As with the file access manager 104, the execution instructor 110 operates, as a part of the OS, in the kernel space. When the presence determiner 106 determines that no valid file is present, the execution instructor 110 instructs the application 103 or the communication processor 109 to obtain a file. The application 103 instructed to obtain the file is determined on the basis of both the path information pertaining to the file to be obtained and predetermined instruction information. The path information may be obtained from the presence determiner 106 or from the file access manager 104. The instruction information may be stored in the storing device 102, or in another storing device 102, not illustrated.

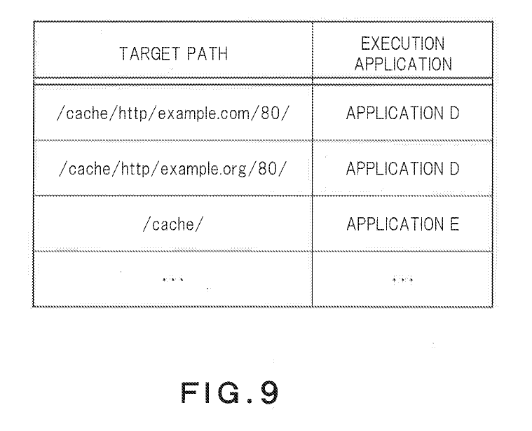

FIG. 9 is a diagram illustrating an example of instruction information. The instruction information is represented in a table of correspondence between the paths and applications 103 as illustrated in FIG. 9, for example. The execution instructor 110 selects a target path that has the longest character string coinciding with that of the path of the obtained path information. Then, the execution instructor 110 instructs the application 103 associated with the selected target path. In the example of FIG. 9, when file access is performed to a file under the directory “/cache/http/example.com/80/” or “/cache/http/example.org/80/”, the application 103D is instructed. When file access is performed to a file that is not under any of the two directories but is under the directory “/cache/” instead, the application 103E is instructed.

It is assumed that the application 103 having performed the file access is different from the application 103 provided with the file obtaining instruction. Alternatively, the files may be identical to each other. A case may be adopted where the application 103 is not instructed to obtain the file. The communication processor 109 may be instructed to obtain the file as with the first embodiment, or an error may be notified without issuance of the obtaining instruction.

The application 103 provided with the file obtaining instruction is instructed by the execution instructor. Accordingly, this application opens a predetermined file, such as a device file system, through the “open” system call, calls a “select” system call and a “poll” system call, and waits for an execution instruction. The execution instructor 110 instructs the application 103 via the device file system. Consequently, in the instruction information described above, the file name such as of the device file system may be associated with the path. A file obtaining instruction may be issued using the file name.

In instructing the application 103, the execution instructor 110 transmits the path information to the application 103. In this case, the header information on the file may be passed to the application 103. The application 103 can determine whether the header and body are required to be updated on the basis of the fields, such as “Expires”, “max-age”, “Last-Modified” and “Date” of the header information, for example. Thus, it is possible to prevent unnecessary writing from occurring even without necessity of update. When writing is unnecessary, the application 103 may notify the unnecessity to the other applications 103, the reader 107, the writer 108 and the like which are waiting for completion of writing, via the device file system and the like.

In a case where the data processing apparatus 1 is connected to the network via a plurality of communicators 101, the execution instructor 110 may designate a communicator 101 to be used by this application 103. For example, the communicator 101 may be designated by transmitting the identifier of the communicator 101 to the application 103 to be instructed by the execution instructor 110.

For example, a case is assumed where a first communicator 101 is connected to a first communication line, a second communicator 101 is connected to a second communication line, and the first communication line has a higher usage fee but has a higher band than the second communication line does. In such a case, the second communication line is normally used, while the first communication line may sometimes be desired to be used for a specific file or a specific source of obtainment. The execution instructor 110 selects the communication line to be used, on the basis of the situation of the communication line and the file to be obtained, and transmits, to the application 103, the identifier of the communicator 101 connected to the communication line to be used. The application 103 obtains the file via the communicator 101 associated with the identifier. The desired communication line can thus be used.

Alternatively, the application 103 may use a preliminarily associated communicator 101. For example, it is preliminarily defined that the application 103D uses the first communicator 101 connected to the first communication line, and the application 103E uses the second communicator 101 connected to the second communication line. Then, a target path associated with the application 103D is preliminarily registered in the instruction information. The target path is pertaining to a file to be transmitted in the first communication line or the communication destination with which communication is to be made via the first communication line. Thus, the execution instructor 110 provides an instruction of obtaining the file to be transmitted in the first communication line for the application 103D preliminarily associated with the first communicator 101. Consequently, the desired communication line can be used.

When the applications 103D and 103E receive an instruction from the execution instructor 110, a file receiving instruction is issued to the communication processor 109 to thereby obtain the file via the communication processor 109. It is assumed that the applications 103D and 103E are, for example, proxy servers (cache servers) or the like that write an obtained web page and the like as cache.

The applications 103D and 103E instruct the communication processor 109 to obtain the data, on the basis of the path information. For example, when the path information is “/cache/http/example.com/80/dir1/file1/body”, the file of “http://example.com:80/dir1/file1” is tried to be obtained.

The file obtaining methods are different according to the schemers. In a case of HTTP, the application 103 requests the OS to create a socket for communicating in TCP with the port “80” of “example.com”, and tries to obtain the file using a “GET” method or the like after establishment of connection. Unlike the first embodiment, the file obtained by the communication processor 109 is not passed to the writer 108 but is passed to the application 103D or 103E. Thus, the file is passed between the application 103D or 103D and the communication processor 109 via the socket.

The applications 103D and 103E call the system call for writing in order to write, in the storing device 102, the file obtained from the communication processor 109. The process pertaining to file writing is analogous to that of the first embodiment.

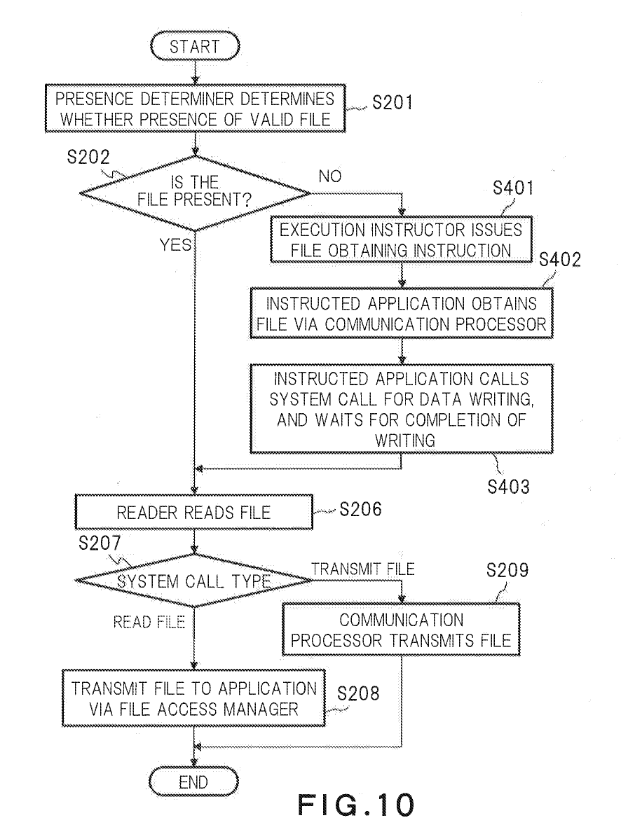

Next, the flow of process of this embodiment is described. The schematic process of the data processing apparatus 1 according to this embodiment is analogous to that of the first embodiment. However, the reading process is different from that of the first embodiment. FIG. 10 is a diagram illustrating an example of a flowchart of a reading process of the data processing apparatus 1 according to the second embodiment. This flow is a flow of allowing the application 103 to obtain the file.

The process in the case where the determination result of the presence determiner 106 is true (YES in S202) is analogous to that of the first embodiment. When the determination result of the presence determiner 106 is false (NO in S202), unlike the first embodiment the execution instructor 110 instructs the application 103 to obtain the file on the basis of the path information and the Instruction information (S401). When the obtaining instruction is issued, the path information is transmitted in order to obtain the file.

The application 103 having received the obtaining instruction obtains the designated file via the communication processor 109 on the basis of the path information (S402). The application 103 having received the designated file calls the system call for writing the file, and waits for completion of writing (S403). The flow of the process in response to the system call for writing the file is performed according to the schematic process flow and the writing process flow of the first embodiment. Finally, the file access manager 104 notifies completion of writing to the reader 107. As with the first embodiment, the reader 107 to which the completion of writing has been notified reads the file (S206) and performs the process according to the type of the system call (S208 and S209), and this flow is finished.

As described above, this embodiment allows the application 103 different from the application 103 having requested the file to execute the process of obtaining the file and the like. Thus, only the reliable application 103 is allowed to perform the writing process, thereby enabling the reliability to be improved. Furthermore, the communication line to be used can be selected according to the specific file or the specific source of obtainment. Thus, in consideration of the usage fee, band, load, delay and the like of the communication line, the communication line is appropriately used.

### Third Embodiment

In a third embodiment, through use of a TCP/IP offload engine (TOE), the processes pertaining to the reader 107, the writer 108 and the communication processor 109 are executed in hardware. This execution reduces the processing load on the processor in comparison with the above embodiments, and increases the speed of the process.

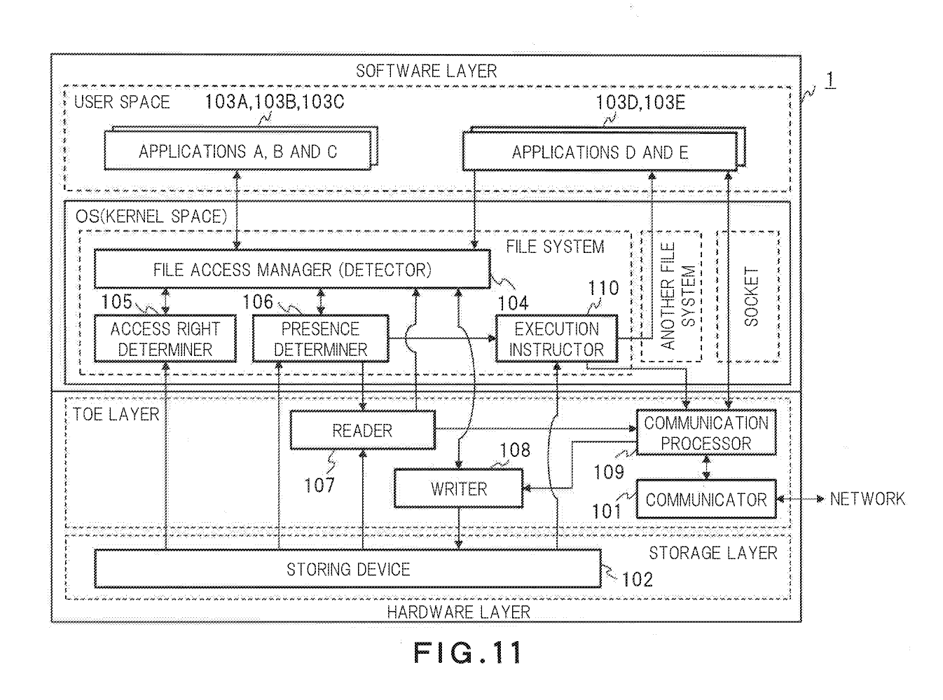

FIG. 11 is a block diagram illustrating an example of a schematic configuration of a data processing apparatus 1 according to the third embodiment. The reader 107, the writer 108 and the communication processor 109 are illustrated in a hardware layer. FIG. 11 illustrates an example that implements the second embodiment in TOE. Alternatively, the first embodiment may be implemented in TOE.

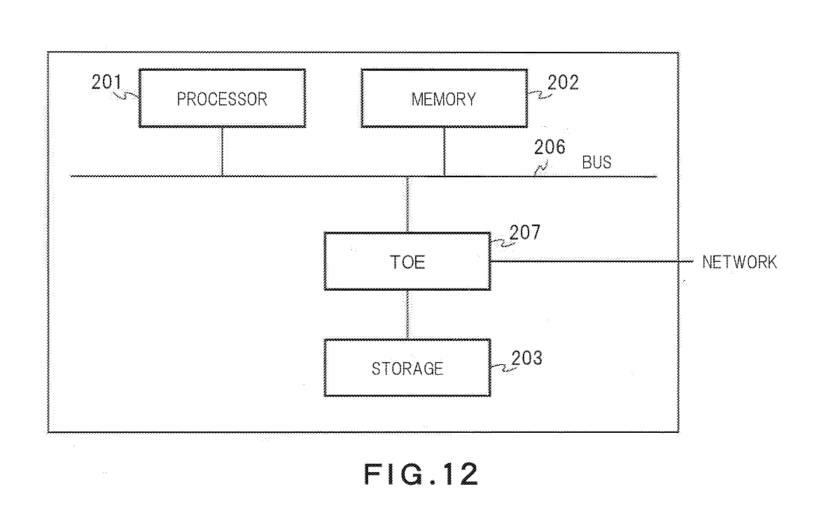

FIG. 12 is a block diagram illustrating an example of a hardware configuration according to the third embodiment. In the hardware configuration according to the third embodiment, instead of the network adaptor 204, a TOE 207 is connected to a bus 206. Without the host bus adaptor 205, the storage 203 is connected to the TOE 207, and is connected to the bus 206 via the TOE 207.

The TOE 207 implements the reader 107, the writer 108, the communication processor 109 and the communicator 101. The storage 203 implements the storing device 102. Thus, data is exchanged between the storage 203 and the TOE 207 at high speed through the hardware. For example, advantageous effects are exerted in a case where the communication processor 109 reads the file from the storing device 102 and transmits the file, and in a case where the file obtained by the communication processor 109 is directly written in the storing device 102.

The TOE 207 device driver operating in the kernel space enables data to be exchanged between the memory 202 and the TOE 207 and enables a program operating in the kernel space to access the storage 203. This allows processes, such as reading of the access right information in the storing device 102 by the access right determiner 105, determination of presence of a valid cache by the presence determiner 106, and reading of the instruction information by the execution instructor 110, to be performed as with the above embodiments.

According to the third embodiment, in a case where the “sendfile” system call is called for the reading process and a valid file is present in the storing device 102, the function of the TOE 207 allows the reader 107 to read data directly from the storing device 102 and allows the data to be transmitted via the communication processor 109 without intervention of the processor 201.

In the third embodiment, the process in a case where any valid file is not present in the storing device 102 in the reading process is different from that in the second embodiment. According to the second embodiment, in the above case, the application 103 provided with the obtaining instruction by the execution instructor 110 obtains the file via the communication processor 109 and then calls the system call for writing, thus performing the writing process. In the writing process, the writer 108 obtains the file from the application 103 through the file access manager 104. On the other hand, in the third embodiment, the writer 108 directly obtains the file from the communication processor 109. Thus, the process of software is reduced, and the speed of the process is increased.

According to the third embodiment, when the application 103 provided with the obtaining instruction by the execution instructor 110 obtains the file via the communication processor 109, this application uses a “recvfile” system call, which is intrinsic to the TOE 207.

The “recvfile” system call performs an operation inverted to that of “sendfile”.

According to the “recvfile” system call, when the socket, the file descriptor, the file offset, and the length of data are designated, data received through the socket is written by the designated length from the offset position in the file. That is, receiving and writing of the file is performed in an integrated manner.

The application 103 provided with the file obtaining instruction identifies the schemer, the host name and the port number on the basis of the path information, and creates the socket. Next, the file whose data is to be stored is opened through the “open” system call, and an instruction for writing the received file is issued through the “recvfile” system call. For example, in the case of HTTP, the TCP socket is created using the Identified host name and port number. Next, a file is created through the “open” system call for each of the header and body. Through the “send” system call for the socket, the “GET” method, “HEAD” method of HTTP are issued, and then the “recvfile” system call is called.

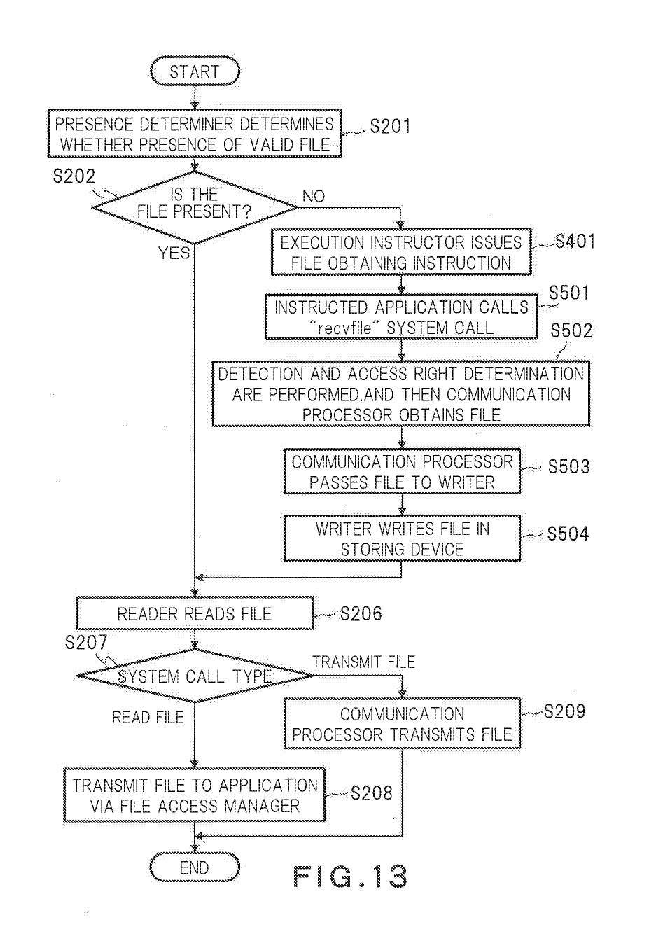

FIG. 13 is a diagram illustrating an example of a flowchart of a reading process of the data processing apparatus according to the third embodiment. The processes up to the process of the execution instructor 110 issuing a file obtaining instruction (S401) are analogous to those in the second embodiment.

An application instructed to obtain the file performs necessary processes such as socket creating in order to call the “recvfile” system call (S501). The called “recvfile” system call is processed in a manner analogous to that of the other system calls, such as “read” and “write”.

That is, as illustrated in the flow of the schematic process in FIG. 5, the “recvfile” system call is detected by the file access manager 104, the determination process by the access right determiner 105 is performed. When the determination result is permitted, that is, the file access is permitted, the process of the “recvfile” system call (S502 to S504 in FIG. 13) not illustrated in FIG. 5 is started. The communication processor 109 obtains the file pertaining to the obtaining instruction (S502) and passes the obtained file to the writer 108 (S503). The writer 108 writes the file from the communication processor 109 into the storing device (S504). The processes thereafter are analogous to those of the first and second embodiments.

A part of file writing may be performed through the application 103. For example, the writer 108 may obtain the header from the application 103, and obtain the body from the communication processor 109.

As described above, according to this embodiment, the received data is directly written in the storing device 102 of the storage 203 from the communication processor 109 of the TOE 207 by the TOE 207 device driver without intervention of the application 103. Thus, even when the application 103 for obtaining the file is designated, the received file can be written in the storing device 102 without intervention of the processor 201, the memory 202 and the bus 206, thereby allowing the process to be performed at high speed. The loads, such as the processor 201 and the memory 202, or the band of the bus 206 can be reduced.

### Fourth Embodiment

A fourth embodiment assumes that the data processing apparatus 1 has a virtual instance by a virtualization technique (virtual machine or container), and provides a multi-tenant service.

The virtualization technique is a technique that creates one or more virtual data processing apparatuses on one data processing apparatus. Here, the actual data processing apparatus 1 that executes the virtualization technique is called a physical instance, and the virtual data processing apparatus is called a virtual instance. The kernel space of the virtual data processing apparatus is called a virtual kernel space. The user space of the virtual data processing apparatus is called a virtual user space. It is herein assumed that the programs that operate in the virtual user space are also included in “applications”.

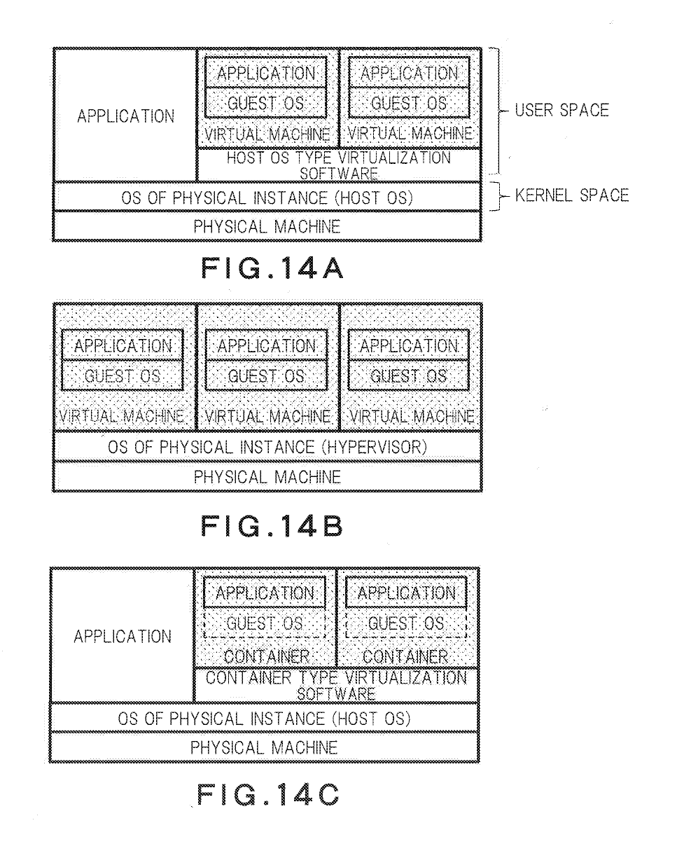

FIGS. 14A, 14B and 14C are diagrams illustrating examples of virtualization techniques. A virtualization technique for a host type OS is illustrated in FIG. 14A. A hypervisor type virtualization technique is illustrated in FIG. 14B. A container type virtualization technique is illustrated in FIG. 14C. In this embodiment, any of these virtualization techniques may be used. Dotted areas indicate virtual instances. Each virtualization technique can create one or more virtual instances on the physical instance.

According to the host OS type virtualization technique, virtualization software that operates as a part of the OS on the physical instance implements one or more virtual machines. According to the host OS type virtualization technique, a virtual OS (guest OS) is Installed on each virtual machine, and the application 103 operates on the guest OS. The guest OS and the host OS may be identical to or different from each other. The guest OSs on a plurality of virtual machines may be identical to or different from each other. According to the host OS type virtualization technique, in the user space of the physical instance, the application 103 other than the virtualization software can be executed.

According to the hypervisor type virtualization technique, a plurality of virtual machines are implemented by the hypervisor corresponding to the OS of the physical instance. As with the host OS type virtualization technique, in the plurality of created virtual machines, the guest OS is installed, and the application operates on the guest OS. The guest OS and the host OS may be Identical to or different from each other. The guest OSs on a plurality of virtual machines may be identical to or different from each other. According to the hypervisor type virtualization technique, the application cannot be executed in an area other than the virtual machine.

According to the container type virtualization technique, virtualization software that operates as a part of the OS on the physical instance creates a plurality of containers. A container is a space separated from the other containers by means of the name space, resource limitation and the like. In the container, the application can be operated. The guest OS of each container shares the OS of the physical instance. Consequently, the guest OS is the same as the OS of the physical instance.

In general, exchange of data between different instances is performed by virtual communication through a virtual LAN (virtual switch) created by the OS of the physical instance. Consequently, when data is exchanged between the instances, memory copy by network access occurs. For example, when a web application in each instance obtains a file from an external network, even though a shared proxy server constructed for a certain instance is used, the data is obtained from the shared proxy server through virtual communication. Consequently, there is a problem in that the processing load and time are increased.

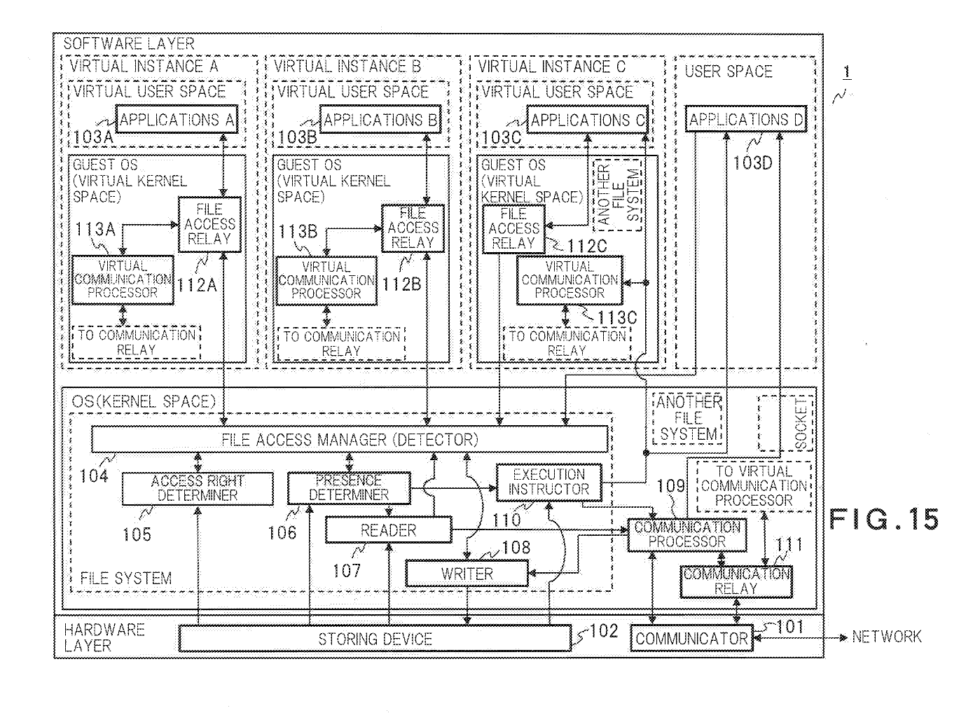

FIG. 15 is a block diagram illustrating an example of a schematic configuration of a data processing apparatus 1 according to a fourth embodiment. In the data processing apparatus 1 according to the fourth embodiment, at least one virtual instance is generated. This apparatus includes a guest OS that operates in the virtual kernel space of the virtual instance.

It is assumed that the applications 103A, 103B and 103C are executed in the user space of each virtual instance. It is assumed that the application 103D is executed in the user space of the physical instance. The type of the application 103 is not specifically limited. For example, the application may be the kernel or an application for managing another application 103. Description is herein made assuming that the applications 103A and 103B are web servers that transmit files, and the applications 103C and 103D are proxy servers that obtain the files.

FIG. 15 illustrates the user space of the physical instance where the application 103D is present. In a case where the hypervisor type virtualization technique is used, the user space of the physical instance is absent.

As with the second embodiment, the file access manager 104, the access right determiner 105, the presence determiner 106, the reader 107, the writer 108, the communication processor 109, and the execution instructor 110 are executed in the kernel space of a physical instance. In the case where the file is obtained directly by the communication processor 109 as with the first embodiment, the execution instructor 110 is not necessarily provided.

This embodiment further includes a file access relay 112 and a virtual communication processor 113 which operate in the kernel space of each virtual instance, and a communication relay 111 which operates in the kernel space of the physical instance.

The file access relay 112 is an interface of the file system in the virtual instance. When the application 103 operating in the virtual user space calls a system call pertaining to a file in the storing device 102, the file access relay 112 in the same virtual instance detects this system call.

The file access relay 112 can access the file system to which the file access manager 104 of the physical instance belongs, and relays the obtained system call to the file access manager 104. Thus, the file access manager 104 can detect the system call of the application 103 operating in the virtual user space. Consequently, the application 103 operating in the virtual instance can perform the file access to the file in the storing device 102 of the hardware via the file access relay 112 and the file access manager 104.

The virtual communication processor 113 is the communication processor 109 in the kernel space of the virtual instance. The application 103 of the virtual instance performs transmission and reception of the file with an external apparatus via the virtual communication processor 113. The virtual communication processor 113 exchanges data with the communication relay 111 operating in the kernel space in the physical instance.

The communication relay 111 is for establishing communication connection between each virtual communication processor 113 of the corresponding virtual instance and the communicator 101 in the hardware layer. The communication processor 109 of the physical instance may also be connected to the communicator 101 via the communication relay 111.

In this embodiment, information on the instance where the application 103 operates may be included in the application execution information included in the system call. The access right determiner 105 may determine file access permission or prohibition on the basis of the information on the instance where the application 103 operates.

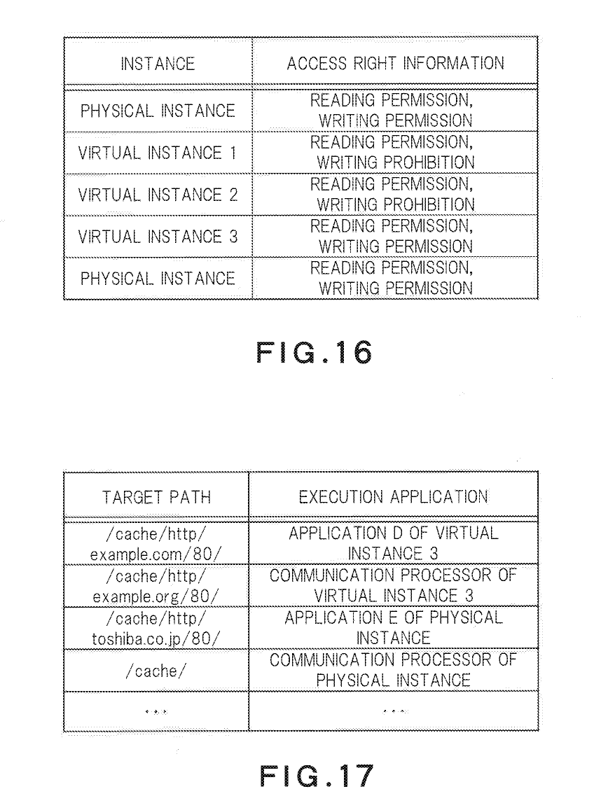

FIG. 16 is a diagram illustrating an example of access right information according to the fourth embodiment. In the access right information illustrated in FIG. 16, the permission information is defined on an instance-by-instance basis. Thus, the access right information according to this embodiment may include the permission information pertaining to the instance. Consequently, the access right determiner 105 can determine the file access permission or prohibition on an instance-by-instance basis. As with the previous embodiments, the access right may be determined in each of the applications 103. The file access permission or prohibition may be determined on the basis of both the instance and the application 103.

As with the second embodiment, it is assumed that when the execution instructor 110 issues an instruction of obtaining the file on the basis of instruction information, the instruction information used by the execution instructor 110 contains the instance where the application 103 operates. FIG. 17 is a diagram illustrating an example of instruction information according to the fourth embodiment. Not only the application 103 but also an instance where the application 103 operates is illustrated. Thus, the execution instructor 110 can recognize the instance where the application 103 operates. Alternatively, the execution instructor 110 may issue the file obtaining instruction, not to the application 103, but to the communication processor 109 or the virtual communication processor 113 of the virtual instance where the application 103 operates.

When the execution instructor 110 issues an obtaining instruction to the application 103 of the virtual instance, the instruction is issued through another file system, such as the device file systems of the physical instance and virtual instance, to which the file access manager 104 and the file access relay 112 do not belong.

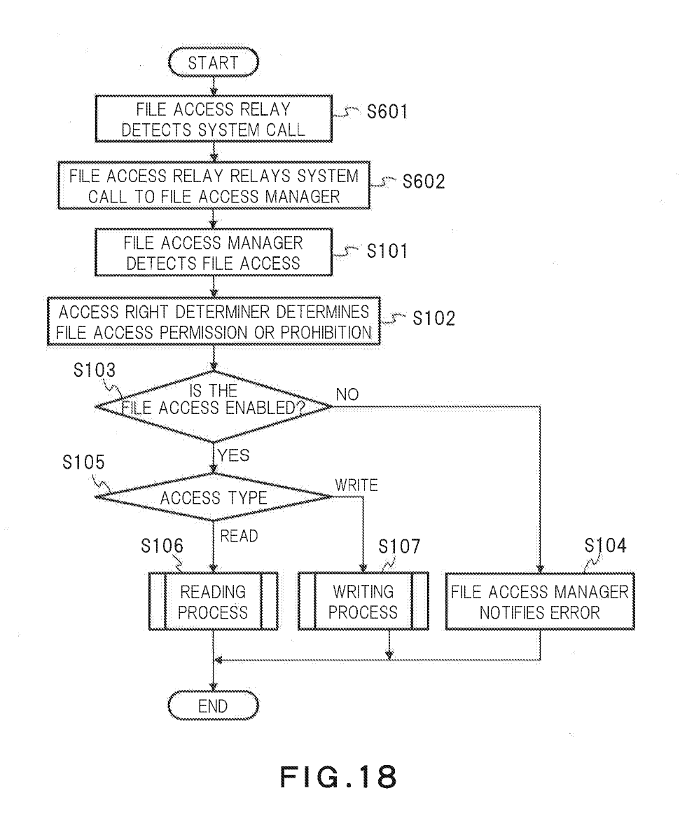

FIG. 18 is a diagram illustrating an example of a schematic process of a flowchart of the data processing apparatus 1 according to the fourth embodiment. This flow is started when the application 103A or 103B calls the system call.

When the application 103A or 103B calls the system call, the application 103A or 103B operates in the user space of the virtual instance and thus the file access relay 112 operating in the kernel space of the virtual instance detects the system call (S601). The file access relay 112 relays the system call to the file access manager 104 (S602). The processes after relay of the system call by the file access relay 112 to the file access manager 104 are analogous to those of the first embodiment. However, data exchange between the file access manager 104 and the application 103 of the virtual instance is performed via the file access relay 112 in the error notifying process (S104), the process of transmitting the read file to the application 103 (S208) and the like, for example. Data exchange between the application 103 of the virtual instance and the communication processor 109 is performed via the virtual communication processor 113 when the application 103 transmits the file, for example.

The data processing apparatus 1 may include a plurality of communicators 101 and a plurality of communication relays 11. In this case, the execution instructor 110 may transmit the identifier of the communication relay 111 to thereby designate the communication relay 111 to be used by the application 103 operating in the virtual user space.

Alternatively, each instance may use a preliminarily associated communicator 101. For example, it is preliminarily defined that the virtual instance D uses the first communicator 101 connected to the first communication line, and the physical instance uses the second communicator 101 connected to the second communication line. The target path pertaining to file to be transmitted in the first communication line or the communication destination with which communication is to be made is associated with the application 103D. Then, the target path associated with the application 103D is preliminarily registered in the instruction information. Thus, the execution instructor 110 provides an instruction of obtaining the file to be transmitted in the first communication line for any of applications of the virtual instance D preliminarily associated with the first communicator 101. The desired communication line can thus be used.

Also in the fourth embodiment, the TOE 207 may be used as with the third embodiment. Thus, the loads, such as the processor 201 and the memory 202, or the band of the bus 206 can be reduced.

The above embodiments describe the example of obtainment through HTTP. Alternatively, the present invention may be applied to a content-oriented network which is called ICN (Information Centric Networking) or CCN (Content Centric Networking).

As described above, this embodiment can achieve advantageous effects analogous to those of the previous embodiments even in an environment where multi-tenants by the virtualization technique are provided. Thus, this embodiment does not perform virtual communication, thereby allowing increase in processing load and processing time to be reduced.

Writing to the shared cache can be limited on an instance-by-instance basis.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data processing apparatus including a storing device configured to store a file, and an operating system configured to operate in a kernel space,
wherein the operating system comprises:
a file access manager configured to detect a file access to a file in the storing device by an application operating in a user space;
a presence determiner configured to determine whether the file pertaining to the file access detected by the file access manager is stored in the storing device; and
a writer configured to write the file pertaining to the file access detected by the file access manager into the storing device when the presence determiner determines that the file pertaining to the file access is not stored in the storing device.

2. The data processing apparatus according to claim 1,
wherein when the presence determiner determines that the file pertaining to the file access is not stored in the storing device, the writer writes the file pertaining to the file access detected by the file access manager into the storing device even without a writing instruction by an application having performed the file access detected by the file access manager.

3. The data processing apparatus according to claim 1, further comprising a communicator configured to communicate with an external apparatus,
wherein the operating system further comprises a communication processor configured to control the communicator to thereby receive the file pertaining to the file access detected by the file access manager, from the external apparatus, and
the writer obtains, from the communication processor, the file pertaining to the file access detected by the file access manager.

4. The data processing apparatus according to claim 3,
wherein the operating system further comprises an execution instructor configured to issue an instruction for obtaining the file pertaining to the file access detected by the file access manager to an application identical to or different from the application having performed the file access detected by the file access manager, based on a determination result of the presence determiner,
the communication processor receives, from the external apparatus, the file pertaining to the file access detected by the file access manager, according to an instruction by the application having received the obtaining instruction from the execution instructor, and
when the file access manager detects the writing instruction issued by the application having, received the obtaining instruction from the execution instructor, the writer writes, into the storing device, the file from the application having received the obtaining instruction from the execution instructor.

5. The data processing apparatus according to claim 1, further comprising a guest operating system configured to operate in a virtual kernel space of a virtual instance generated by a virtualization technique,
wherein the guest operating system comprises a file access relay configured to detect a file access to a file in the storing device by an application operating in a virtual user space of the virtual instance, and relays the file access to the file access manager, and
the file access manager detects the file access relayed by the file access relay.

6. The data processing apparatus according to claim 4, further comprising a guest operating system configured to operate in a virtual kernel space of a virtual instance generated by a virtualization technique,
wherein the guest operating system further comprises:
a file access relay configured to detect a file access to a file in the storing device by an application operating in a virtual user space of the virtual instance, and relay the file access to the file access manager; and
a virtual communication processor configured to control the communicator to receive, from the external apparatus, the file subjected to the obtaining instruction by the application operating in the virtual user space, and
the file access manager detects the file access relayed by the file access relay,
when the application subjected to the obtaining Instruction from the execution instructor operates in the user space, the communication processor receives the file pertaining to the file access detected by the file access manager, and
when the application subjected to the obtaining instruction from the execution instructor operates in the virtual user space, the virtual communication processor receives the file pertaining to the file access detected by the file access manager.

7. The data processing apparatus according to claim 4,
wherein the execution instructor determines the application that is to be provided with the obtaining instruction, based on instruction information that indicates the application associated with a file or a directory in the storing device.

8. The data processing apparatus according to claim 4, comprising a plurality of communicators,
wherein the execution instructor provides the obtaining instruction for an application preliminarily associated with a desired communicator.

9. The data processing apparatus according to claim 4, comprising a plurality of communicators,
wherein the execution instructor transmits an identifier of the communicator to the application that is to be provided with the obtaining instruction, and
the file pertaining to the file access detected by the file access manager is received from the external apparatus via the communicator corresponding to the identifier.

10. The data processing apparatus according to claim 3,
wherein the writer, the communicator and the communication processor are implemented by a TCP/IP offload engine, and
the storing device is implemented by a storage connected to the TCP/IP offload engine.

11. The data processing apparatus according to claim 1,
wherein the presence determiner determines whether the file pertaining to the file access detected by the file access manager is stored in the storing device and expiration time has not been reached.

12. The data processing apparatus according to claim 1,
wherein the operating system further comprises an access right determiner configured to determine permission or prohibition of the file access detected by the file access manager, based on an access right set in a file or a directory in the storing device, and
when the file pertaining to the file access is determined not to be stored in the storing device, the writer does not write the file pertaining to the file access detected by the file access manager into the storing device.

13. A data processing method of causing an operating system of a data processing apparatus that includes a storing device configured to store a file, and the operating system configured to operate in a kernel space, to execute:
detecting a file access to a file in the storing device by an application operating in a user space;
determining whether the file pertaining to the detected file access is stored in the storing device; and
writing the file pertaining to the detected file access into the storing device when it is not determined that the file pertaining to the detected file access is stored in the storing device.

14. A non-transitory computer readable medium having a computer program for causing an operating system of a data processing apparatus that includes a storing device configured to store a file and the operating system configured to operate in a kernel space, to execute:
file access managing that detects a file access to a file in the storing device by an application operating in a user space;
presence determining that determines whether the file pertaining to the file access detected by the file access managing is stored in the storing device; and
writing the file pertaining to the detected file access into the storing device when it is not determined that the file pertaining to the detected file access is stored in the storing device.
